(19) United States
(12) Patent Application Publication
(10) Pub. No.: US 2025/0057250 A1
(43) Pub. Date: Feb. 20, 2025

(54) AEROSOL PROVISION DEVICE

(71) Applicant: Nicoventures Trading Limited, London (GB)

(72) Inventors: Jorge GOMEZ, London (GB); Matthew HOLDEN, London (GB); Conor MCGRATH, London (GB)

(21) Appl. No.: 18/723,442

(22) PCT Filed: Dec. 19, 2022
(86) PCT No.: PCT/EP2022/086811

§ 371 Date: Jun. 23, 2024

(30) Foreign Application Priority Data
Dec. 23, 2021 (GB) 2118947.7

(51) Int. Cl. A24F 40/60; A24F 40/40; A24F 40/70

(52) U.S. Cl. CPC A24F 40/60; A24F 40/40; A24F 40/70

(57) ABSTRACT

An aerosol provision device includes a body and a button assembly on the body. The button assembly includes a button member, a support frame and a resilient arm. The resilient arm connects the support frame to the button member. A flexible sealing member extends between the support frame and the button member. Also disclosed are a button assembly for an aerosol provision device and a method of manufacturing a button assembly for an aerosol provision device.

### RELATED APPLICATIONS

The present application is a National Phase entry of PCT Application No. PCT/EP2022/086811 filed Dec. 19, 2022, which claims priority to GB Application No. 2118947.7 filed Dec. 23, 2021, each of which is hereby incorporated by reference in their entirety.

### TECHNICAL FIELD

The present invention relates to an aerosol provision device. The present invention also relates to a button assembly for an aerosol provision device and a method of manufacturing a button assembly for an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating aerosol from an aerosol generating material, comprising: a body; and a button assembly on the body, the button assembly comprising: a button member; a support frame; a resilient arm connecting the support frame to the button member; and a flexible sealing member extending between the support frame and the button member.

The resilient arm may be elongate.

The resilient arm may extend from an outer edge of the button member. At least part of the resilient arm may extend at least substantially parallel to the outer edge of the button member.

The button member may be at least partially received in the support frame.

The support frame may comprise an inner edge. At least a portion of the resilient arm may extend at least substantially parallel to the inner edge of the support frame.

The resilient arm may comprises an arm member, a first connector portion extending between the arm member and the button member and a second connector portion extending between the arm member and the support frame.

The resilient arm may have a Z-shape between the button member and the support frame.

A thickness of the resilient arm may be less than the thickness of the button member. A thickness of the resilient arm may be less than the thickness of the support frame.

The button member and the resilient arm may form a one-piece component. The support frame and the resilient arm may form a one-piece component.

The resilient arm may be a first resilient arm. The button assembly may comprise a second resilient arm connecting the support frame to the button member. The first and second arms may extend from opposing sides of the button member.

The support frame, resilient arm, button member and flexible sealing member may be integrally formed.

The flexible sealing member may form a fluid barrier.

The support frame, resilient arm, button member and flexible sealing member may together form a fluid barrier.

The flexible sealing member may extend around the button member.

The flexible sealing member may be an overmold.

The button member may be spaced from the support frame.

The flexible sealing member may fill the space between the support frame and the button member.

The body may comprise a housing, and the support frame may be mounted to the housing. The support frame may be welded to the housing. The support frame may be sonic welded to the housing.

The housing may comprise an aperture and the button member may be received in the aperture.

The body may comprise a chassis in the housing and the support frame may be at least partially received between the chassis and the housing.

The body may comprise a printed circuit board disposed behind the button assembly and connected to the button assembly by at least one alignment pin. The aerosol provision device may comprise a reinforcement member behind the printed circuit board.

The printed circuit board may be a flexible printed circuit.

In accordance with some embodiments described herein, there is provided an aerosol provision device, comprising: a body; and a button assembly on the body, the button assembly comprising: a button member; a support frame; a first resilient arm extending between the support frame and the button member, and a second resilient arm extending between the support frame and the button member wherein the first resilient member is relatively more resilient than the second resilient member.

Each resilient arm may be elongate.

Each resilient arm may extend from an outer edge of the button member. At least part of each resilient arm may extend at least substantially parallel to the outer edge of the button member.

The button member may be at least partially received in the support frame.

The support frame may comprise an inner edge. At least a portion of each resilient arm may extend at least substantially parallel to the inner edge of the support frame.

Each resilient arm may comprises an arm member, a first connector portion extending between the arm member and the button member and a second connector portion extending between the arm member and the support frame.

Each resilient arm may have a Z-shape between the button member and the support frame.

A thickness of each resilient arm may be less than the thickness of the button member. A thickness of each resilient arm may be less than the thickness of the support frame.

The button member and resilient arms may form a one-piece component. The support frame and the resilient arms may form a one-piece component.

The first and second resilient arms may extend from opposing sides of the button member.

The support frame, resilient arms, button member and flexible sealing member may be integrally formed.

The support frame, resilient arms, button member and flexible sealing member may together form a fluid barrier.

The flexible sealing member may form a fluid barrier.

The flexible sealing member may extend around the button member.

The flexible sealing member may be an overmold.

The button member may be spaced from the support frame.

The flexible sealing member may fill the space between the support frame and the button member.

The body may comprise a housing, and the support frame may be mounted to the housing. The support frame may be welded to the housing. The support frame may be sonic welded to the housing.

The housing may comprise an aperture and the button member may be received in the aperture.

The body may comprise a chassis in the housing and the support frame may be at least partially received between the chassis and the housing.

The body may comprise a printed circuit board disposed behind the button assembly and connected to the button assembly by at least one alignment pin. The aerosol provision device may comprise a reinforcement member behind the printed circuit board. The printed circuit board may be a flexible printed circuit.

In accordance with some embodiments described herein, there is provided a button assembly for an aerosol provision device, comprising: a button member; a support frame; a resilient arm connecting the support frame to the button member; a flexible sealing member extending between the support frame and the button member.

The resilient arm may be elongate.

The resilient arm may extend from an outer edge of the button member. At least part of the resilient arm may extend at least substantially parallel to the outer edge of the button member.

The button member may be at least partially received in the support frame.

The support frame may comprise an inner edge. At least a portion of the resilient arm may extend at least substantially parallel to the inner edge of the support frame.

The resilient arm may comprises an arm member, a first connector portion extending between the arm member and the button member and a second connector portion extending between the arm member and the support frame.

The resilient arm may have a Z-shape between the button member and the support frame.

A thickness of the resilient arm may be less than the thickness of the button member. A thickness of the resilient arm may be less than the thickness of the support frame.

The button member and the resilient arm may form a one-piece component. The support frame and the resilient arm may form a one-piece component.

The resilient arm may be a first resilient arm. The button assembly may comprise a second resilient arm connecting the support frame to the button member. The first and second arms may extend from opposing sides of the button member.

The support frame, resilient arm, button member and flexible sealing member may be integrally formed.

The flexible sealing member may form a fluid barrier.

The support frame, resilient arm, button member and flexible sealing member may together form a fluid barrier.

The flexible sealing member may extend around the button member.

The flexible sealing member may be an overmold.

The button member may be spaced from the support frame.

The flexible sealing member may fill the space between the support frame and the button member.

In accordance with some embodiments described herein, there is provided a method of manufacturing a button assembly for an aerosol provision device, comprising: forming a button configuration comprising a support frame, a button member at least partially received in the support frame, and an arm extending between the button member and the support frame; and overmolding a flexible sealing member to extend at least partially around the button between the button and the support frame.

The method may comprise sonic welding the frame to a housing of the aerosol provision device, such that the button member is received in an aperture in the housing of the aerosol provision device.

### BRIEF DESCRIPTION OF THE DRAWINGS

Embodiments of the invention will now be described, by way of example only, with reference to accompanying drawings, in which:

FIG. 1 shows a front view of an aerosol provision device;

FIG. 2 shows a schematic cross-sectional side view of the aerosol provision device of FIG. 1;

FIG. 3 shows a perspective view of a button assembly of the aerosol provision device of FIG. 1;

FIG. 4 shows a cross-sectional perspective view of the button assembly of FIG. 3;

FIG. 5 shows a part cutaway perspective view of part of the aerosol provision device of FIG. 1;

FIG. 6 shows a part cutaway perspective view of part of the aerosol provision device of FIG. 1; and

FIG. 7 shows a perspective view of an alternative configuration of a button assembly of the aerosol provision device of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt% or 70 wt % of amorphous solid, to about 90 wt %, 95 wt% or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

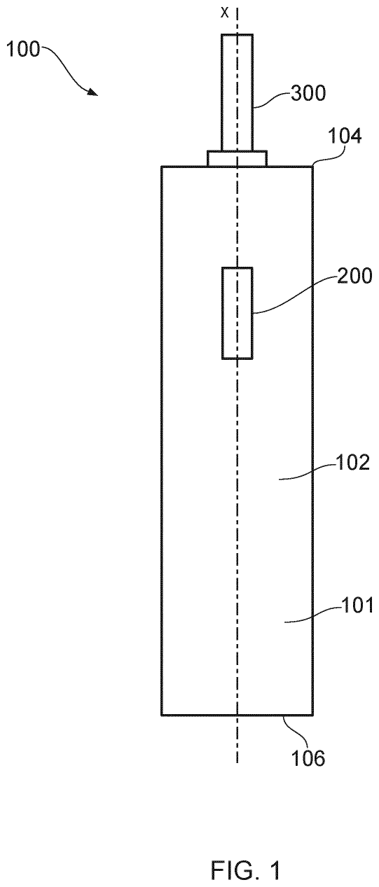

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable medium which is inhaled by a user of the device 100. The article 300 and the device 100 together form an aerosol provision system.

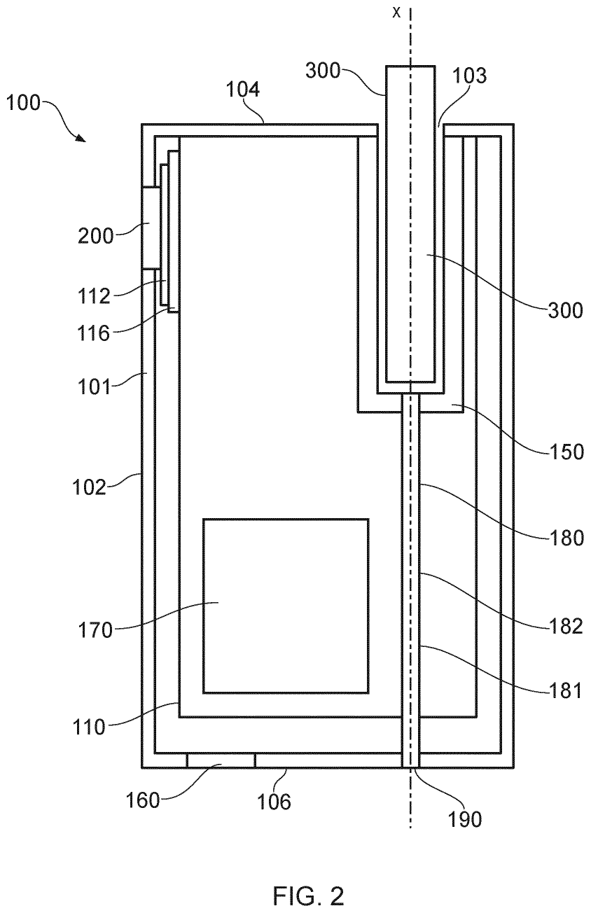

The device 100 comprises a body 101. A housing 102 surrounds and houses various components of the body 101. An opening 103 in formed at one end of the body 101, through which the article 300 may be inserted for heating by an aerosol generator 150 (refer to FIG. 2). In use, the article 300 may be fully or partially inserted into the aerosol generator 150 where it may be heated by one or more components of the aerosol generator 150.

The device 100 also includes a button assembly 200, which operates the device 100 when pressed. The button assembly 200 will be described in detail below. For example, a user may turn on the device 100 by operating the button assembly 200.

The aerosol generator 150 defines a longitudinal axis X.

FIG. 2 shows a schematic cross sectional view of the device 100. The device 100 comprises an electrical component, such as a connector/port 160, which can receive a cable to charge a battery of the device 100. For example, the connector 160 may be a charging port, such as a USB charging port. In some examples the connector 160 may be used additionally or alternatively to transfer data between the device 100 and another device, such as a computing device.

The device 100 comprises a power source 170, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 150 to supply electrical power when required and under control of a controller to heat the aerosol generating material.

A chassis 110 supports the power source 170 and other components.

The device 100 comprises an electronics module 112. The electronics module 112 may comprise, for example, a printed circuit board (PCB). The PCB may support at least one controller, such as a processor, and memory. The PCB may also comprise one or more electrical tracks to electrically connect together various electronic components of the device 100. For example, the battery terminals may be electrically connected to the PCB so that power can be distributed throughout the device 100. The chassis 110 comprises a PCB mount.

The body 102 has end surfaces of the device 100. The end of the device 100 closest to the opening 103 may be known as the proximal end (or mouth end) 104 of the device 100 because, in use, it is closest to the mouth of the user. In use, a user inserts an article 300 into the aperture 103, operates the aerosol generator 150 to begin heating the aerosol generating material and draws on the aerosol generated in the device. This causes the aerosol to flow through the device 100 along a flow path towards the proximal end of the device 100.

The other end of the device furthest away from the aperture 103 may be known as the distal end 106 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, one-piece component refers to a component of the device 100 which is not separable into two or more components following assembly of the device 100. Integrally formed relates to two or more features that are formed into a one piece component during a manufacturing stage of the component.

An air flow passage 180 extends through the body 101. The airflow passage 180 extends to an opening 190. The opening 190 acts as an air inlet.

In one example, the aerosol generator 150 comprises an induction-type heating system, including a magnetic field generator. The magnetic field generator comprises an inductor coil assembly. The aerosol generator 150 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 150 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly includes an inductor coil. In embodiments, the number of inductor coils differs. In embodiments, a two or more inductor coils are used. The inductor coil assembly also comprises a coil support. The coil support is tubular.

The heating element is part of a heating assembly. The heating element of this example is hollow and therefore defines at least part of a receptacle within which aerosol generating material is received. For example, the article 300 can be inserted into the heating element. The heating element is tubular, with a circular cross section. The heating element has a generally constant diameter along its axial length.

The heating element is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The aerosol generator 200 may therefore comprise electrical contacts for electrical connection with the apparatus for electrically activating the heating element by passing a flow of electrical energy through the heating element.

The receptacle and article 300 are dimensioned so that the article 300 is received by the heating element. This helps ensure that the heating is most efficient. The article 300 of this example comprises aerosol generating material. The aerosol generating material is positioned within the receptacle. The article 300 may also comprise other components such as a filter, wrapping materials and/or a cooling structure.

The air flow passage 180 extends from the heating element. The air flow passage 180 is at the first, distal, end. The air flow passage 180 protrudes from the heating element. The air flow passage 180 extending from the heating element 220 is defined by a flow path member 182. The heating element 220 and the flow path member 182 forms part of an airflow path arrangement 181.

The flow path member 182 extends between the heating element and the opening 190. The flow path member 182 is tubular. The flow path member 182 defines a bore. The flow path member extends in an axial direction along its length.

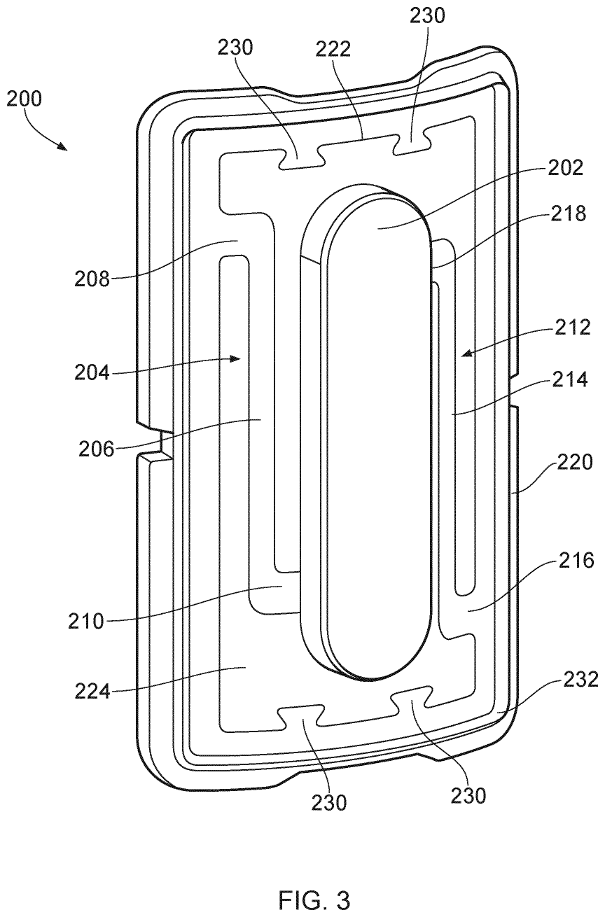

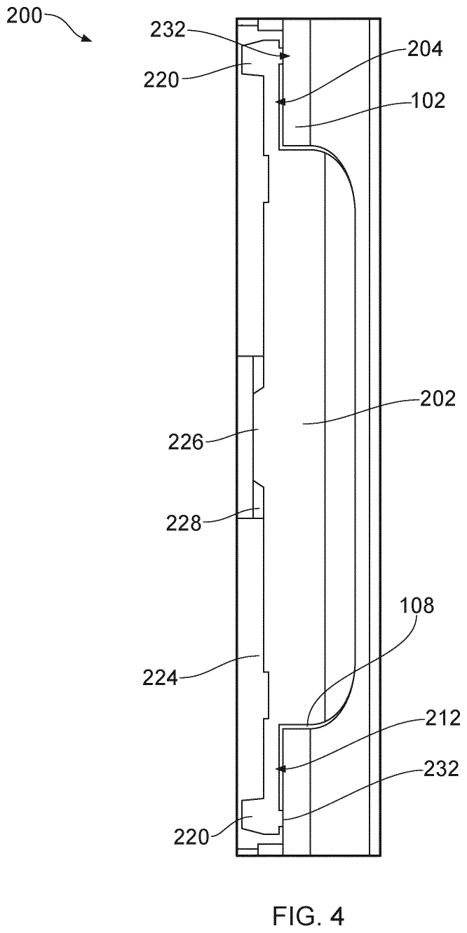

FIG. 3 shows a perspective view of a button assembly 200 for the aerosol provision device 100. FIG. 4 shows a cross-sectional perspective view of the button assembly 200. The button assembly 200 comprises a button member 202 and a support frame 220.

The support frame 220 is a hollow rectangular member. The button member 202 is partially received in the support frame 220. The button member 202 has a height such that it protrudes above a plane defined by the support frame 220. The button member 202 is spaced from the support frame 220. The button member 202 includes a front face 234, for activation by a user. The button member 202 includes a protrusion 226 on a rear surface of the button member. The rear surface of the button member is opposite the front face 234 of the button member. That is, the protrusion 226 and front face 234 are disposed on opposite sides of the button member.

The button assembly 200 includes a first resilient arm 204 and a second resilient arm 212. The resilient arms 204, 212 are elongate. The resilient arms 204, 212 extend from an outer edge of the button member. Each resilient arm 204, 212 connects the button member 202 to the support frame 220. The resilient arms 204, 212 are connected to opposite side of the button member 202. The resilient arms 204, 212 are co-planar with the support frame 220.

The first resilient arm 204 includes an arm member 206, a first connector portion 208 and a second connector portion 210. In this embodiment, the arm member 206, first connector portion 208 and second connector portion 210 are a one-piece component. In other embodiments, they may be separate components joined together.

An end of the first connector portion 208 is joined to the support frame 220. The first connector portion 208 is joined to an inner edge 222 of the support frame 220. Another end of the first connector portion 208 is joined to an end of the arm member 206. An end of the second connector portion 210 is joined to the button member 202. Another end of the second connector portion 210 is joined to an end of the arm member 206. The arm member 206 is disposed parallel to the outer edge of the button member 202. The arm member 206 is disposed parallel to the inner edge 222 of the support frame 220. The first and second connector portions 208, 210 are disposed transverse to the outer edge of the button member 202. The first resilient arm therefore has a Z-shape between the button member 202 and the support frame 220. In embodiments, the connector portions are omitted or have a different arrangement. In embodiments the arms have a different configuration, such as L-shape or V-shape.

The thickness of the resilient arms 204, 212 is less than the thickness of the button member 202. In other embodiments, the thickness of the resilient arms 204, 212 is greater than the thickness of the button member 202. The thickness of the resilient arms 204, 212 is less than the thickness of the support frame 220. In other embodiments, the thickness of the resilient arms 204, 212 is greater than the thickness of the support frame 220.

The second resilient arm 212 also includes an arm member 214, a first connector portion 216 and a second connector portion 218. The arm member 214, first connector portion 216 and second connector portion 218 of the second resilient arm 212 are similar to those of the first resilient arm 204.

The button assembly 200 includes a flexible sealing member 224. The flexible sealing member is joined to the support frame 220. The flexible sealing member is joined to the inner edge 222 of the support frame 220. The flexible sealing member seals the space within the support frame 220. The flexible sealing member fills the space between the support frame 220 and the button member 202. The flexible sealing member 224 is also joined to the resilient arms 204, 212 and button member 202. In this embodiment, the flexible sealing member 224 is an overmold on the support frame 220, button member 202 and resilient arms 204, 212. In other embodiments, the flexible sealing member 224 extends around the button member 202. That is, the button member may protrude through the flexible sealing member 224 and be joined to the flexible sealing member 224. The flexible sealing member is disposed on a rear surface of the button assembly 200. The rear surface is opposite the front surface, which is provided by a face of the button member 202 and which is operated by a user. The flexible sealing member 224 provides a fluid barrier to prevent fluid ingress to the interior of the device 100.

The flexible sealing member 224 is made of a plastics material. In embodiments, the flexible sealing member may be made of silicone. The flexible sealing member may be made of substantially and flexible material capable of providing a seal.

The button member 202, resilient arms 204, 212 and support frame 232 are a one piece component. In this embodiment, the button member 202, resilient arms 204, 212 and support frame 232 are made of a plastics material. In other embodiments, the button member 202, resilient arms 204, 212 and support frame 232 may be separate components. The button member 202, resilient arms 204, 212 and support frame 232 may be made of a metallic material.

The flexible sealing member 224 includes an aperture 228. The aperture 228 is disposed behind the button member 202. The aperture 228 is sealed by the button member 202. The protrusion 226 of the button member 202 is received in the aperture 228.

The support frame 220 includes a plurality of lugs 230. The lugs 230 are protrusions from the inner edge 222 of the support frame. In this embodiment, the lugs 230 and the support frame 220 are a one-piece component. The lugs 230 provide a stronger join between the flexible sealing member 224 and the support frame 220.

The support frame 220 includes a ridge 232. The ridge 232 is provided on the front surface of the support frame. The ridge 232 extends around a periphery of the support frame 220. The ridge 232 describes a closed path. The ridge 232 assists in providing a fluid tight seal between the support frame 220 and the housing 102.

The button assembly 200 provides a fluid seal. This prevents moisture or debris from entering the interior of the aerosol provision device via the button assembly 200. In embodiments, the fluid seal is provided entirely by the flexible sealing member 224. In embodiments, the fluid seal is provided by the flexible sealing member 224 in combination with one or more of the resilient arms 204, 212, button member 202 and support frame 220.

The housing 102 of the aerosol provision device 100 includes an aperture 108. The button assembly 200 is disposed adjacent to the aperture 108. The button member 202 protrudes through the aperture 108. The support frame 220 is joined to the housing 102. The support frame 220 is sonic welded to the housing 102.

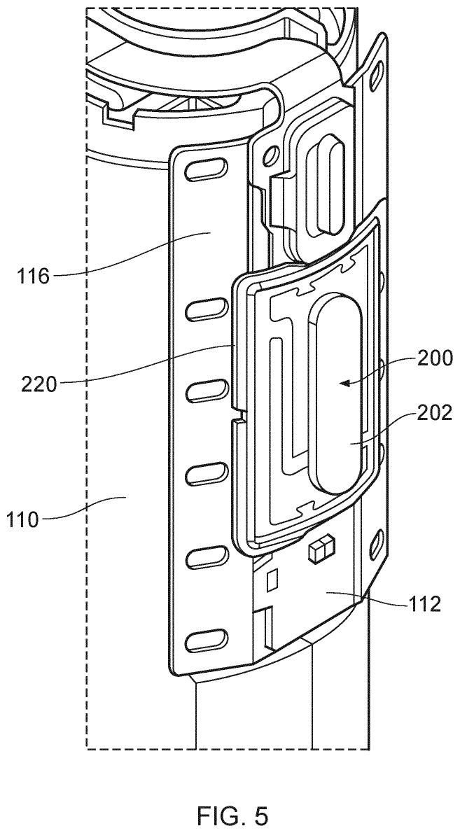

FIG. 5 shows a part cut away perspective view of part of the aerosol provision device of FIG. 1. The button assembly 200 is mechanically aligned with a button actuator component on the electronics module 112 so that the button assembly 200 may be used to control the aerosol provision device 100.

A reinforcement member 116 is provided behind the button assembly 200. In this embodiment, the electronics module 112 is disposed between the reinforcement member 116 and the button assembly 200. The button assembly 200 is disposed between the reinforcement member 116 and the housing 102. The reinforcement member 116 therefore holds the electronics module 112 and the button assembly 200 to the housing 102.

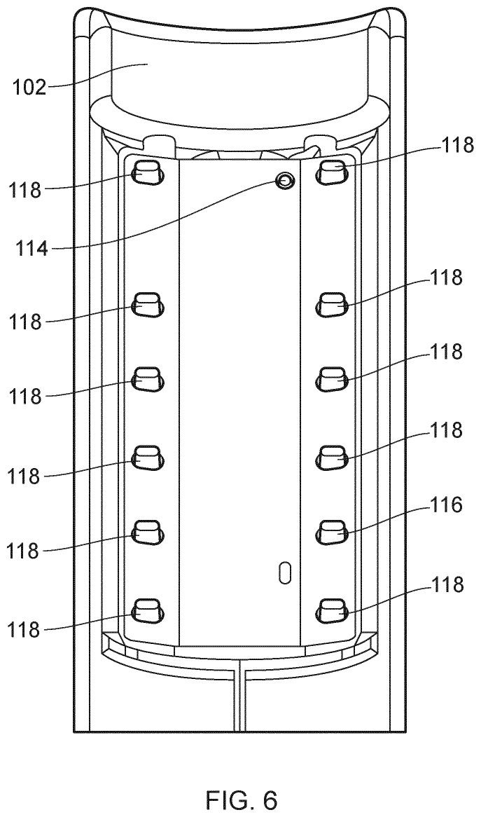

The reinforcement member 116 is a plate. The reinforcement member is joined to the housing 102 (refer to FIG. 6). The housing 102 comprises a plurality of pins 118, extending through a plurality of apertures in the reinforcement member 116. The pins 118 are formed of a plastics material. The reinforcement member 116 is heat staked to the pins 118, to join it to the housing 102. In this embodiment, 12 pins 118 are provided. The button assembly 200 is disposed between the reinforcement member 116 and the housing 112. The reinforcement member 116 is formed of stainless steel. In other embodiments, the reinforcement member 116 is formed of another material, for example polyetheretherketone. The reinforcement member 116 provides additional support to the button assembly 200 when under compression during activation.

An alignment pin 114 protrudes from the housing 102. The alignment pin passes through an aperture in the reinforcement member 116.

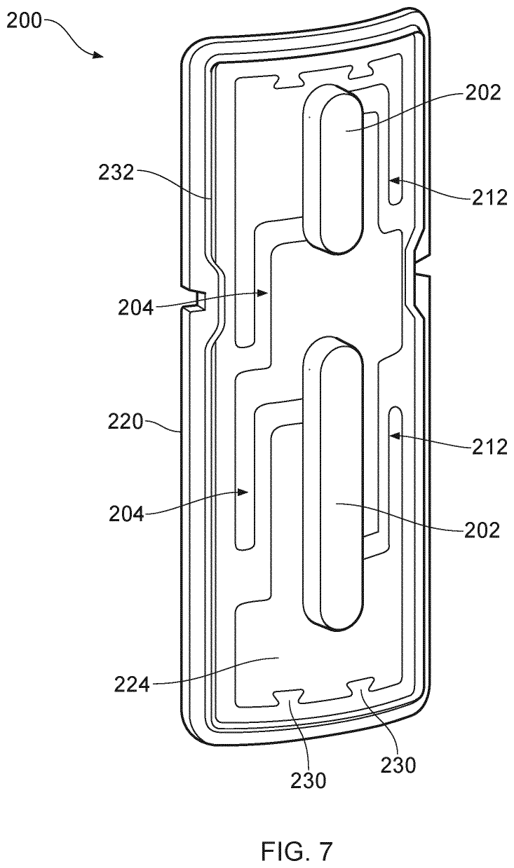

FIG. 7 shows a perspective view of a second embodiment of a button assembly 200 for the aerosol provision device of FIG. 1. The second embodiment is similar to the button assembly 200 of FIG. 3, except that two button members 202 are provided. The support frame extends around both button members 202. It will be understood that the number of button members 202 may vary. Each button member is connected to the support frame 220 by respective first and second resilient arms 204, 212. The first and second resilient arms are similar to those described in relation to FIG. 3.

Also disclosed is a method of manufacturing a button assembly for an aerosol provision device. The method comprises forming a button configuration comprising a support frame, a button member at least partially received in the support frame, and an arm extending between the button member and the support frame.

The method further comprises overmolding a flexible sealing member to extend at least partially around the button between the button and the support frame.

The method further comprises sonic welding the frame to a housing of the aerosol provision device, such that the button member is received in an aperture in the housing of the aerosol provision device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating aerosol from an aerosol generating material, comprising:
a body; and
a button assembly on the body, the button assembly comprising:
a button member;
a support frame;
a resilient arm connecting the support frame to the button member; and
a flexible sealing member extending between the support frame and the button member.

2. An aerosol provision device as claimed in claim 1, wherein the resilient arm is elongate.

3. An aerosol provision device as claimed in claim 1, wherein the resilient arm extends from an outer edge of the button member and at least part of the resilient arm extends at least substantially parallel to the outer edge of the button member.

4. An aerosol provision device as claimed in claim 1, wherein the button member is at least partially received in the support frame.

5. An aerosol provision device as claimed in claim 1, wherein the support frame comprises an inner edge and at least a portion of the resilient arm extends at least substantially parallel to the inner edge of the support frame.

6. An aerosol provision device as claimed in claim 1, wherein the resilient arm comprises an arm member, a first connector portion extending between the arm member and the button member and a second connector portion extending between the arm member and the support frame.

7. An aerosol provision device as claimed in claim 1, wherein the resilient arm has a substantially Z-shape between the button member and the support frame.

8. An aerosol provision device as claimed in claim 1, wherein a thickness of the resilient arm is less than the thickness of the support frame.

9. An aerosol provision device as claimed in claim 1, wherein the button member and the resilient arm form a one-piece component.

10. An aerosol provision device as claimed in claim 1, wherein the support frame and the resilient arm form a one-piece component.

11. An aerosol provision device as claimed in claim 1, wherein the resilient arm is a first resilient arm and the button assembly comprises a second resilient arm connecting the support frame to the button member.

12. An aerosol provision device as claimed in claim 1, wherein the support frame, resilient arm, button member and flexible sealing member are integrally formed.

13. An aerosol provision device as claimed in claim 1, wherein the flexible sealing member forms a fluid barrier.

14. An aerosol provision device as claimed in claim 1, wherein the flexible sealing member extends around the button member.

15. An aerosol provision device as claimed in claim 1, wherein the body comprises a housing and a chassis in the housing and the support frame is mounted to the housing and at least partially received between the chassis and the housing.

16. An aerosol provision device as claimed in claim 1, wherein the body comprises a printed circuit board disposed behind the button assembly and connected to the button assembly by at least one alignment pin.

17. An aerosol provision device as claimed in claim 16, comprising a reinforcement member behind the printed circuit board.

18. An aerosol provision device for generating aerosol from an aerosol generating material, comprising:
a body; and
a button assembly on the body, the button assembly comprising:
a button member;
a support frame;
a first resilient member extending between the support frame and the button member, and a second resilient member extending between the support frame and the button member,
wherein the first resilient member is relatively more resilient than the second resilient member.

19. A button assembly for an aerosol provision device, comprising:
a button member;
a support frame;
a resilient arm connecting the support frame to the button member;
a flexible sealing member extending between the support frame and the button member.

20. A method of manufacturing a button assembly for an aerosol provision device, comprising:
forming a button configuration comprising a support frame, a button member at least partially received in the support frame, and an arm extending between the button member and the support frame; and
overmolding a flexible sealing member to extend at least partially around the button between the button and the support frame.
